(19) United States
(12) Patent Application Publication
(10) Pub. No.: US 2014/0169050 A1
(43) Pub. Date: Jun. 19, 2014

(54) BLANKING CONTROL CIRCUIT FOR CONTROLLING SYNCHRONOUS RECTIFIER AND METHOD OF CONTROLLING SYNCHRONOUS RECTIFIER USING THE CIRCUIT

(71) Applicant: SAMSUNG ELECTRO-MECHANICS CO.LTD., Gyeonggi-do (KR)

(72) Inventors: Jung Chul GONG, Suwon-si (KR); Jong Rok Kim, Suwon-si (KR); Hwan Cho, Suwon-si (KR)

(73) Assignee: SAMSUNG ELECTRO-MECHANICS CO.LTD., Gyeonggi-do (KR)

(21) Appl. No.: 13/802,511

(22) Filed: Mar. 13, 2013

(30) Foreign Application Priority Data
Dec. 18, 2012 (KR) 10-2012-0148429

(51) Int. Cl. H02M 7/21

(52) U.S. Cl. CPC H02M 7/21
USPC 363/89

(57) ABSTRACT

Disclosed herein are a blanking control circuit for controlling a synchronous rectifier and a method of controlling the synchronous rectifier by using the blanking control circuit. The blanking control circuit for controlling a synchronous rectifier includes: a power generating unit that receives power from the outside to generate a reference voltage and a bias current that are used in an integrated circuit (IC); a driving unit that receives the reference voltage and the bias current generated by using the power generating unit to generate a voltage for driving a switch of the synchronous rectifier; and a load sensing unit that determines a state of a load by sensing an output voltage of the synchronous rectifier driven by the driving unit, and generates a corresponding signal if the state of the load is in a low load state so as to turn off the switch of the synchronous rectifier.

### CROSS REFERENCE(S) TO RELATED APPLICATIONS

This application claims the benefit under 35 U.S.C. Section 119 of Korean Patent Application Serial No. 10-2012-0148429, entitled “Blanking Control Circuit for Controlling Synchronous Rectifier and Method of Controlling Synchronous Rectifier Using the Circuit” filed on Dec. 18, 2012, which is hereby incorporated by reference in its entirety into this application.

### BACKGROUND OF THE INVENTION

1. Technical Field

The present invention relates to a synchronous rectifier, and more particularly, to a blanking control circuit for controlling a synchronous rectifier, which is capable of determining a state of a load by directly monitoring an output voltage of the synchronous rectifier and switching on or off the synchronous rectifier according to determination results so as to increase an efficiency of a synchronous rectifier control system, and a method of controlling a synchronous rectifier by using a blanking control circuit.

2. Description of the Related Art

In general, in order to maximize the efficiency of a converter, conduction loss is minimized by using a metal-oxide-semiconductor field-effect transistor (MOSFET) switch instead of a rectifier diode. However, at a predetermined level of a load current or lower, power loss in regard to power for driving the MOSFET switch becomes greater than the conduction loss.

According to a method of controlling a synchronous rectifier (SR) according to the conventional art, as illustrated in FIG. 1, if a load is reduced, a duty of a switch (1^{st} gate) at a primary side of a transformer of the synchronous rectifier is reduced. Accordingly, a current flowing through a secondary side of the transformer of the synchronous rectifier is reduced, and a duty of a control unit (SR gate) of the synchronous rectifier is also reduced.

If the duty is reduced to a predetermined level or lower, the control unit of the synchronous rectifier recognizes this state as a low load, and turns off a gate of an SR MOSFET. Then, a current flows to a body diode of the SR MOSFET to thereby increase conduction loss but since gate switching is not conducted, switching loss may be reduced. That is, according to the conventional art, by using the variation of the duty of the SR gate according to a load switching loss is reduced by forcibly turning off an SR gate if the duty reaches a predetermined level or lower.

However, according to the conventional art, if the duty is reduced to a predetermined level or lower, the load state is recognized as a “low load,” and the gate of the SR MOSFET is forcibly turned off. Thus, if the duty has decreased to a predetermined level or lower due to certain reasons even though the load has not decreased, problems (e.g., sudden turning-off of light or stop of a motor) may occur when the gate of the SR MOSFET is forcibly turned off.

In addition, if the load is actually lowered but the duty is not reduced due to certain reasons, switching loss of the SR gate (that is, power loss in regard to driving the MOSFET switch) may continuously occur.

### SUMMARY OF THE INVENTION

An object of the present invention is to provide a blanking control circuit for controlling a synchronous rectifier for improving efficiency of a synchronous rectifier control system by determining a state of a load by directly monitoring an output voltage of a synchronous rectifier and turning off a switch of the synchronous rectifier if the load is in a low load state, and a method of controlling the synchronous rectifier by using the blanking control circuit.

According to an exemplary embodiment of the present invention, there is provided a blanking control circuit for controlling a synchronous rectifier including: a power generating unit that receives power from the outside to generate a reference voltage and a bias current that are used in an integrated circuit (IC); a driving unit that receives the reference voltage and the bias current generated by using the power generating unit to generate a voltage for driving a switch of the synchronous rectifier; and a load sensing unit that determines a state of a load by sensing an output voltage of the synchronous rectifier which is operating by being driven by the driving unit, and generates a corresponding signal if the state of the load is in a low load state so as to turn off the switch of the synchronous rectifier.

The load sensing unit may be configured to detect a state of a load by receiving the output voltage of the synchronous rectifier as feed back by using a feed back regulator included inside the IC of the synchronous rectifier and to generate a blanking control signal if the state of the load is at a predetermined level or lower.

The blanking control circuit for controlling a synchronous rectifier may further include a voltage detecting unit that determines an on/off state of a gate by measuring a voltage of the switch of the synchronous rectifier in order to detect a state of a switch at a primary side of a switch mode power supply (SMPS).

The voltage detecting unit may determine an on/off state of the gate by measuring a negative voltage of the switch of the synchronous rectifier.

The blanking control circuit for controlling a synchronous rectifier may further include a protection circuit unit that protects the synchronous rectifier by sensing an overvoltage applied across the load or a high temperature of the IC and turning off the switch.

According to another exemplary embodiment of the present invention, there is provided a method of controlling a synchronous rectifier by using a blanking control circuit for controlling a synchronous rectifier, the circuit comprising a power generating unit, a driving unit, a load sensing unit, and a voltage detecting unit, the method including: generating a reference voltage and a bias current that are used in an integrated circuit (IC) by receiving power from the outside by using the power generating unit; generating a driving voltage for driving a switch of the synchronous rectifier by receiving the bias current by using the driving unit; determining a state of a load by sensing an output voltage of the synchronous rectifier which is operating by receiving the driving voltage, by using the load sensing unit; and turning off the switch of the synchronous rectifier if the load is in a low load state as a result of the determining.

By using the load sensing unit, a state of a load may be detected by receiving the output voltage of the synchronous rectifier as feed back by using a feedback regulator included inside the IC of the synchronous rectifier, and a blanking control signal may be generated if the state of the load is at a predetermined level or lower.

The method may further include determining an on/off state of a gate by measuring a voltage of the switch of the synchronous rectifier by using the voltage detecting unit in order to detect a state of a switch at a primary side of a switch mode power supply (SMPS).

An on/off state of the gate may be determined by measuring a negative voltage of the switch of the synchronous rectifier by using the voltage detecting unit.

The method may further include protecting the synchronous rectifier by sensing an overvoltage applied across the load or a high temperature of the IC by a protection circuit unit that is included in the blanking control circuit for controlling a synchronous rectifier in order to sense the overvoltage or the high temperature and turning off the switch.

### BRIEF DESCRIPTION OF THE DRAWINGS

FIG. 1 is a graph schematically showing a controlling method of a synchronous rectifier according to the conventional art;

FIG. 2 is a schematic block circuit diagram of a blanking control circuit for controlling a synchronous rectifier according to an embodiment of the present invention;

FIG. 3 illustrates an internal circuit structure of a synchronous rectifier in which a blanking control circuit according to an embodiment of the present invention is used;

FIG. 4 is a flowchart illustrating a method of controlling a synchronous rectifier by using a blanking control circuit for controlling a synchronous rectifier according to an embodiment of the present invention; and

FIG. 5 is a graph schematically showing an operation of a blanking control circuit according to an embodiment of the present invention.

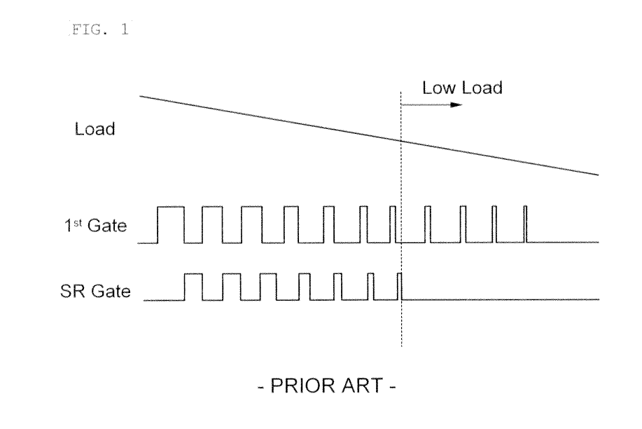

### DESCRIPTION OF THE PREFERRED EMBODIMENTS

Terms and words used in the present specification and claims are not to be construed as a general or dictionary meaning but are to be construed as meaning and concepts meeting the technical ideas of the present invention based on a principle that the inventors can appropriately define the concepts of terms in order to describe their own inventions in best mode.

Thorough the specification, unless explicitly described to the contrary, the word “comprise” and variations such as “comprises” or “comprising”, will be understood to imply the inclusion of stated elements but not the exclusion of any other elements. In addition, the terms “-er”, “-or”, “module”, and “unit” described in the specification mean units for processing at least one function and operation, and can be implemented by hardware components or software components and combinations thereof.

Exemplary embodiments of the present invention will now be described in detail with reference to the accompanying drawings.

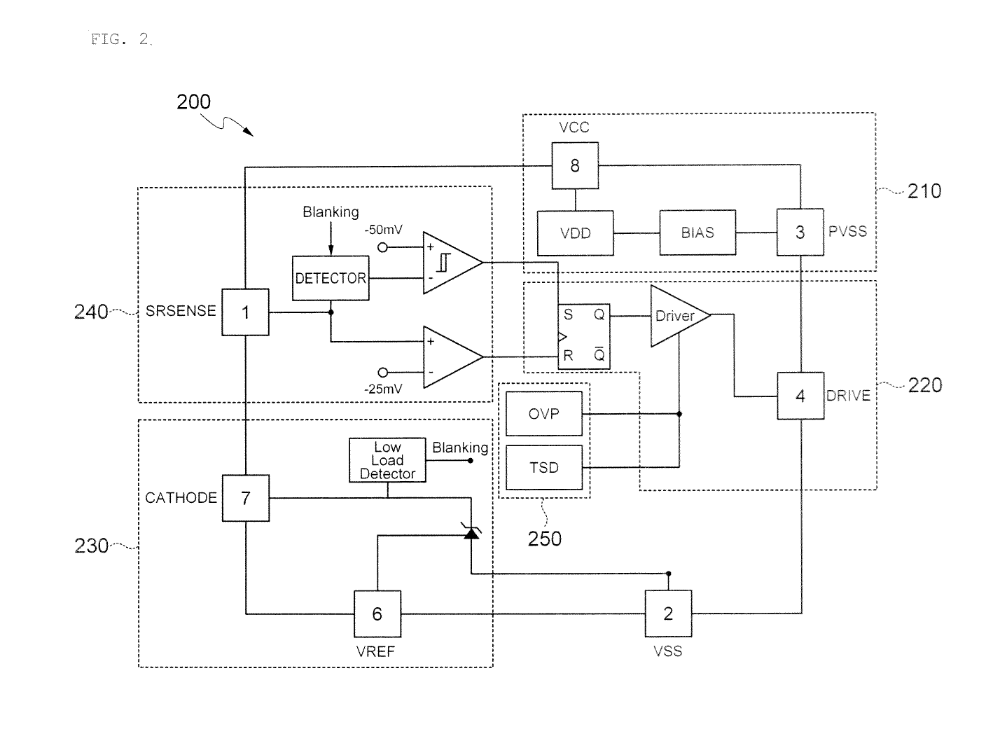

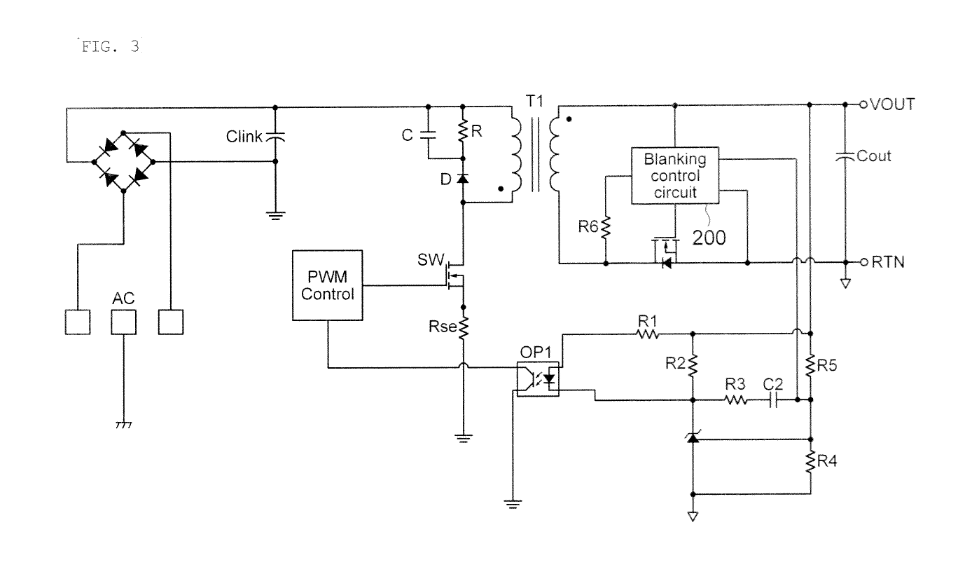

FIG. 2 is a schematic block circuit diagram of a blanking control circuit 200 for controlling a synchronous rectifier according to an embodiment of the present invention, and FIG. 3 illustrates an internal circuit structure of a synchronous rectifier in which the blanking control circuit 200 according to the current embodiment of the present invention is used.

Referring to FIGS. 2 and 3, the blanking control circuit 200 for controlling a synchronous rectifier according to the current embodiment of the present invention includes a power generating unit 210, a driving unit 220, and a load sensing unit 230.

The power generating unit 210 receives power from the outside to generate a reference voltage and a bias current that are used in an integrated circuit (IC).

The driving unit 220 receives the reference voltage and the bias current generated by using the power generating unit 210 to generate a voltage for driving a switch of the synchronous rectifier.

The load sensing unit 230 determines a state of a load by sensing an output voltage of the synchronous rectifier which is operating by being driven by the driving unit 220, and if the load is in a low load state, the load sensing unit 230 generates a corresponding signal to turn off the switch of the synchronous rectifier.

Here, the load sensing unit 230 may be configured to receive the output voltage of the synchronous rectifier as feed back by using a feedback regulator included inside the IC of the synchronous rectifier so as to detect a state of a load, and to generate a blanking control signal if the state of the load is at a predetermined level or lower.

Also, the blanking control circuit 200 may further include a voltage detecting unit 240 that determines an on/off state of a gate by measuring a voltage of the switch of the synchronous rectifier in order to detect a state of a switch at a primary side of a switch mode power supply (SMPS, not shown).

Here, the voltage detecting unit 240 may determine an on/off state of the gate by measuring a negative voltage of the switch of the synchronous rectifier.

Also, the blanking control circuit 200 may further include a protection circuit unit 250 that protects the synchronous rectifier by sensing an overvoltage applied across the load or a high temperature of the IC and turning off the switch.

Hereinafter, a method of controlling a synchronous rectifier by using a blanking control circuit for controlling a synchronous rectifier having the above-described configuration according to the current embodiment of the present invention will be briefly described.

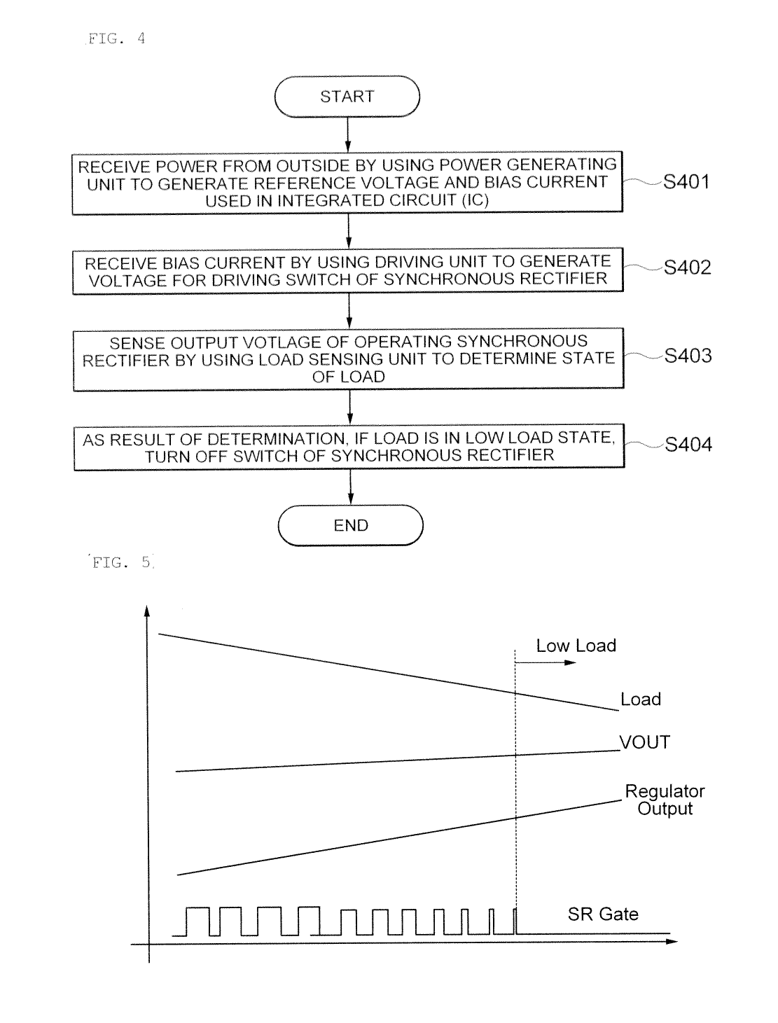

FIG. 4 is a flowchart illustrating a method of controlling a synchronous rectifier by using a blanking control circuit for controlling a synchronous rectifier according to an embodiment of the present invention.

Referring to FIG. 4, according to the method of controlling a synchronous rectifier by using a blanking control circuit for controlling a synchronous rectifier according to the current embodiment of the present invention, the blanking control circuit for controlling a synchronous rectifier, which includes the power generating unit 210, the driving unit 220, the load sensing unit 230, and the voltage detecting unit 240 as described above is used. First, in operation S401, power is received from the outside by using the power generating unit 210 to generate a reference voltage and a bias current that are used in an IC.

Consequently the driving unit 220 receives the bias current to generate a driving voltage for driving a switch of the synchronous rectifier in operation S402.

Next, in operation S403, an output voltage of the synchronous rectifier that is operating upon receiving the driving voltage is sensed by using the load sensing unit 230, thereby determining a state of a load. Here, a state of a load is detected by the load sensing unit 230 by receiving the output voltage of the synchronous rectifier as feed back by using a feedback regulator included inside the IC of the synchronous rectifier, and if the load is in state of a predetermined level or lower, a blanking control signal may be generated.

As a result of the determination of operation S403, if the load is in a low load state, the switch of the synchronous rectifier is turned off in operation S404.

Here, operation S403 will be further explained.

According to the method of the current embodiment of the present invention, the feedback regulator inside the IC of the synchronous rectifier is used to directly monitor the output voltage of the synchronous rectifier and determine whether the load is in a heavy load state or a low load state. That is, when the state of the load is detected based on the fact that in a heavy load state, the output voltage of the feedback regulator inside the IC of the synchronous rectifier is lowered, and in contrast, when the load is in a low load state, the output voltage of the feedback regulator is increased. If the output voltage of the feedback regulator increases over a predetermined value, the state of the load then is regarded as a low load state, and the gate (SR gate) of the switch of the synchronous rectifier is turned off so as to reduce switching loss.

Meanwhile, FIG. 5 is a graph schematically showing an operation of a blanking control circuit according to an embodiment of the present invention.

As illustrated in FIG. 5, a state of a load is detected by using the feedback regulator in the IC of the synchronous rectifier, and if the state of the load is at a predetermined level or lower (i.e., when the output voltage of the feedback regulator is at a predetermined level or higher), a blanking control signal is generated, and a synchronous rectifier control system is turned off to turn off a gate control waveform.

As described above, according to the method of the embodiments of the present invention, the output voltage of the synchronous rectifier is directly monitored (sensed) to determine a load state, and if it is in a low load state, the switch of the synchronous rectifier is turned off so as to increase efficiency of the synchronous rectifier control system.

In regard to a series of operations as described above, the control method according to the embodiments of the present invention may further include determining an on/off state of a gate by measuring a voltage of the switch of the synchronous rectifier by using the voltage detecting unit in order to detect a state of a switch at a primary side of an SMPS.

Here, an on/off state of a gate may be determined by measuring a negative voltage of the switch of the synchronous rectifier by using the voltage detecting unit 240.

In addition, according to the control method of the embodiments of the present invention, the protection circuit unit 250 that senses an overvoltage applied to the blanking control circuit for controlling a synchronous rectifier or a high temperature thereof may be further included, and an operation of protecting the synchronous rectifier by using the protection circuit unit 250 by sensing an overvoltage applied across a load or a high temperature of an IC and turning off the switch may be further included.

As described above, according to the method of controlling a synchronous rectifier by using a blanking control circuit for controlling a synchronous rectifier according to the embodiments of the present invention, instead of controlling a switch of a synchronous rectifier by determining whether a load is in a high or low state according to variation in a duty as in the conventional art, an output voltage of a synchronous rectifier is directly monitored to determine a state of a load, and if the load is in a low load state, a switch of the synchronous rectifier is turned off so as to increase efficiency of the synchronous rectifier control system.

According to the embodiments of the present invention, a state of a load may be determined by directly monitoring an output voltage of the synchronous rectifier, and if the load is in a low load state, a switch of the synchronous rectifier may be turned off, thereby increasing efficiency of a synchronous rectifier control system.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions, and substitutions should also be understood to fall within the scope of the present invention.

What is claimed is:

1. A blanking control circuit for controlling a synchronous rectifier comprising:
a power generating unit that receives power from the outside to generate a reference voltage and a bias current that are used in an integrated circuit (IC);
a driving unit that receives the reference voltage and the bias current generated by using the power generating unit to generate a voltage for driving a switch of the synchronous rectifier; and
a load sensing unit that determines a state of a load by sensing an output voltage of the synchronous rectifier which is operating by being driven by the driving unit, and generates a corresponding signal if the state of the load is in a low load state so as to turn off the switch of the synchronous rectifier.

2. The blanking control circuit for controlling a synchronous rectifier according to claim 1, wherein the load sensing unit is configured to detect a state of a load by receiving the output voltage of the synchronous rectifier as feed back by using a feed back regulator included inside the IC of the synchronous rectifier and to generate a blanking control signal if the state of the load is at a predetermined level or lower.

3. The blanking control circuit for controlling a synchronous rectifier according to claim 1, further comprising a voltage detecting unit that determines an on/off state of a gate by measuring a voltage of the switch of the synchronous rectifier in order to detect a state of a switch at a primary side of a switch mode power supply (SMPS).

4. The blanking control circuit for controlling a synchronous rectifier according to claim 3, wherein the voltage detecting unit determines an on/off state of the gate by measuring a negative voltage of the switch of the synchronous rectifier.

5. The blanking control circuit for controlling a synchronous rectifier according to claim 1, further comprising a protection circuit unit that protects the synchronous rectifier by sensing an overvoltage applied across the load or a high temperature of the IC and turning off the switch.

6. A method of controlling a synchronous rectifier by using a blanking control circuit for controlling a synchronous rectifier, the circuit including a power generating unit, a driving unit, a load sensing unit, and a voltage detecting unit, the method comprising:
generating a reference voltage and a bias current that are used in an integrated circuit (IC) by receiving power from the outside by using the power generating unit;
generating a driving voltage for driving a switch of the synchronous rectifier by receiving the bias current by using the driving unit;
determining a state of a load by sensing an output voltage of the synchronous rectifier which is operating by receiving the driving voltage, by using the load sensing unit; and
turning off the switch of the synchronous rectifier if the load is in a low load state as a result of the determining.

7. The method according to claim 6, wherein by using the load sensing unit, a state of a load is detected by receiving the output voltage of the synchronous rectifier as feed back by using a feedback regulator included inside the IC of the synchronous rectifier, and a blanking control signal is generated if the state of the load is at a predetermined level or lower.

8. The method according to claim 6, further comprising determining an on/off state of a gate by measuring a voltage of the switch of the synchronous rectifier by using the voltage detecting unit in order to detect a state of a switch at a primary side of a switch mode power supply (SMPS).

9. The method according to claim 8, wherein an on/off state of the gate is determined by measuring a negative voltage of the switch of the synchronous rectifier by using the voltage detecting unit.

10. The method according to claim 6, further comprising protecting the synchronous rectifier by sensing an overvoltage applied across the load or a high temperature of the IC by a protection circuit unit that is included in the blanking control circuit for controlling a synchronous rectifier in order to sense the overvoltage or the high temperature and turning off the switch.
